(19) United States
(12) Patent Application Publication
(10) Pub. No.: US 2006/0218226 A1
(43) Pub. Date: Sep. 28, 2006

(54) Automatic recording based on preferences

(75) Inventors: Stephen Johnson, Erdenheim, PA (US); Rajesh B. Khandelwal, Bridgewater, NJ (US); Yue Ma, West Windsor, NJ (US); Il-Pyung Park, Princeton Junction, NJ (US); Luyang Li, South Plainfield, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 11/087,876

(22) Filed: Mar. 23, 2005

(51) Int. Cl. G06F 15/16

(52) U.S. Cl. 709/202

(57) ABSTRACT

An intelligent agent has a local component associated with a user device and a network component capable of mobility that will traverse different locations on a network to discover available media content that meets the user's stored preferences. Using published presence information or user schedule information, the intelligent agent will locate a user device accessible to the user and provide notification when media content of interest is discovered. The intelligent agent mediates the media acquisition and delivery process. Content can be delivered to any one or more diverse user devices, based on user instructions or preferences. The intelligent agent interacts with authentication and purchasing mechanisms to effect secure transactions on the user's behalf.

### BACKGROUND OF THE INVENTION

The present invention relates generally to media management. More particularly, the invention relates to a media management system that employs intelligent agents to mediate the automatic downloading and recording of media content based on subscriber preferences.

The downloading of digital media content is becoming an increasingly popular commercial mechanism that has the potential to supplant physical media, such as CDs, DVDs, game cartridges, and the like in many commercial application programs. To be successful, a media delivery system needs to be simple. In addition, the system must take into account the fact that the media content will be enjoyed in a variety of different locations, using a variety of different equipment. For example, music content may be played in home entertainment systems, portable music players, car entertainment systems, personal computers, mobile phones, and so forth. The well-designed media delivery system should take these different playback scenarios into account, so that the downloaded media will play correctly on the device of the user's choice as well as be delivered to the correct device.

### SUMMARY OF THE INVENTION

While considerable strides have been made recently in improving media delivery systems, there still remains much room for improvement. Accordingly, the present system seeks to make the user's downloading experience easier and more enjoyable by providing an intelligent media delivery system that uses intelligent agents to act as a liaison between the consumer and the content providers. According to one aspect of the system, the intelligent agent is aware of a user's content preferences and is able to contact that user to advise when content is available that the user may be interested in. The intelligent agent system also takes advantage of authentication mechanisms to assist in ensuring that the customer or subscriber, and the content provider, are who they say they are. In this way, the intelligent agent helps prevent the spread of viruses and also helps prevent the propagation of unauthorized data transfers.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating examples of different media content delivery across a diverse range of different media playback devices;

FIG. 2 is a block diagram illustrating some of the architectural components of the media delivery system employing intelligent agents.

FIG. 3 is a block diagram illustrating further details of a presently preferred intelligent agent;

FIG. 4 is a network diagram illustrating how intelligent agents exploit mobility to obtain and communicate information over the network; and

FIG. 5 is a flowchart diagram illustrating an exemplary transaction using the media management system.

### DETAILED DESCRIPTION OF THE PREFERRED EMBODIMENTS

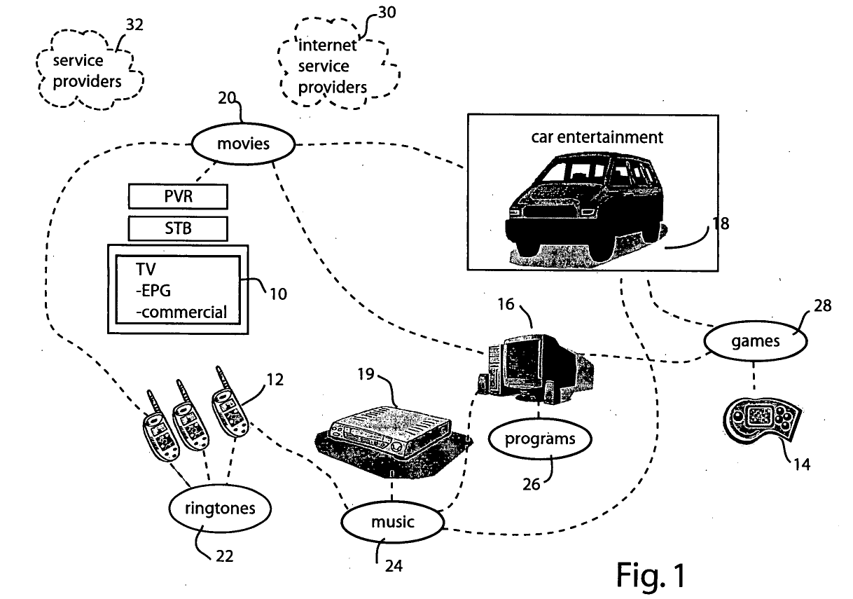

The present invention is well adapted to support the automated downloading and recording of media content across a variety of different media platforms, for a variety of different content enjoyment purposes. Some examples are illustrated in FIG. 1. Specifically, FIG. 1 illustrates different scenarios that each entail a content purchase using one of the illustrated devices (locations), followed by a download to a device appropriate to receive the type of content involved. Thus, by way of example, FIG. 1 illustrates a TV 10, mobile phones 12, game machine 14, personal computer (PC) 16, car entertainment system 18 and media server 19. In FIG. 1 a plurality of different media content have been illustrated diagrammatically as ovals, such as movie content 20, telephone ring tone content 22, music content 24, application program content 26 and game content 28. It will be understood that the devices (locations) and content illustrated in FIG. 1 are merely intended as examples of the types of devices, locations and content that may be utilized with the present invention. Those skilled in the art will appreciate that other devices, locations and content may also be utilized.

As depicted diagrammatically by the dashed lines in FIG. 1, a particular content type may be downloaded to one or more, potentially disparate, devices or locations. Thus music content 24 may be purchased and then downloaded (as illustrated) to the user's cellular telephone 12, to a media server 19, to a personal computer 16 and/or to a car entertainment system 18. Again, the dashed lines are intended to show some of the possible devices or locations upon which a given content can be downloaded and played, but the dashed lines are not intended to represent an exhaustive list of all possible interrelationships.

As will be more fully explained herein, the media management system supports a rich variety of different relationships among devices, such as those illustrated in FIG. 1. Using the system, a user could, for example, use his or her cellular telephone to order the delivery of media content, with the order being carried out by downloading that content to a designated PVR associated with the user's television 10, for example. In this regard, while there are numerous different possibilities and permeations, the following list will illustrate the possibilities:
1. Purchase movie using one of the above and download to STB, PVR, cell phone, PC, etc.
2. Purchase game using one of the above and download to game machine, cell phone, PC, etc.
   While watching a movie, the user is given an option to download a game (e.g., watching “Indiana Jones” movie and downloading “Indiana Jones” game).
3. Purchase music using one of the above and download to PC, media server, MP3 player, etc.
   While watching a movie, the user is given an option to download songs from the movie to audio devices (e.g., PC, MP3 player, etc.)
4. Purchase ring tone using one of the above and download to cell phone.
   While watching a movie, the user is given an option to download the movie theme music as a cell phone ring tone.
   While listening to music on a PC, media server, or MP3 player, etc. the user is given an option to download the music as a ring tone.
5. Purchase computer application program using one of the above and download to PC.

The media management system is further capable of mediating the purchase and delivery of content from a variety of different content providers. For purposes of illustration, FIG. 1 depicts two general groups of such providers. These include Internet service providers 30 and other service providers 32. In general, the Internet service providers handle transactions and deliver media content using the Internet infrastructure. The other service providers 32 generally employ their own dedicated delivery systems and/or networks. These other service providers would thus include cable TV operators, cellular telephone service providers, telephone service providers, satellite media providers, and the like.

The media management system utilizes intelligent agent technology to handle the purchase and downloading operations, so that the user is essentially insulated from all complex details. The system thus empowers the user to identify content of interest, arrange for the purchase or delivery of that content and mediate the actual downloading and storage of the content to one or more devices of the user's choosing. While the invention is well adapted to mediate commercial transactions involving the purchase or rental of selected media, it will be appreciated that the invention is equally capable of supporting delivery of free media content.

By way of further explanation, Table I lists examples of content and how the content can be acquired and downloaded. In Table I examples of content are illustrated, showing examples of where such content might be purchased or acquired from and where the content might be downloaded to. As previously explained, these are merely illustrative examples. Other possibilities within the scope of the invention do exist.

TABLE I

| | Purchase from | |
|---|---|---|
| Content | (acquired from) | Download to |
| Movie | TV | STB |
| | Mobile phone | PVR |
| | Game machine | Mobile phone |
| | PC | PC |
| | Car entertainment system | Car entertainment system |
| Game | TV | Game machine |
| | Mobile phone | Mobile phone |
| | Game machine | PC |
| | PC | Car entertainment system |
| | Car entertainment system | |
| Music | TV | PC |
| | Mobile phone | Media server |
| | Game machine | MP3 player |
| | PC | Car entertainment system |
| | Car entertainment system | |
| Ring tone | TV | Mobile phone |
| | Mobile phone | Media server |
| | Game machine | |
| | PC | |
| | Car entertainment system | |
| Application | TV | PC |
| program | Mobile phone | Mobile phone |
| | Game machine | Car entertainment system |
| | PC | |
| | Car entertainment system | |

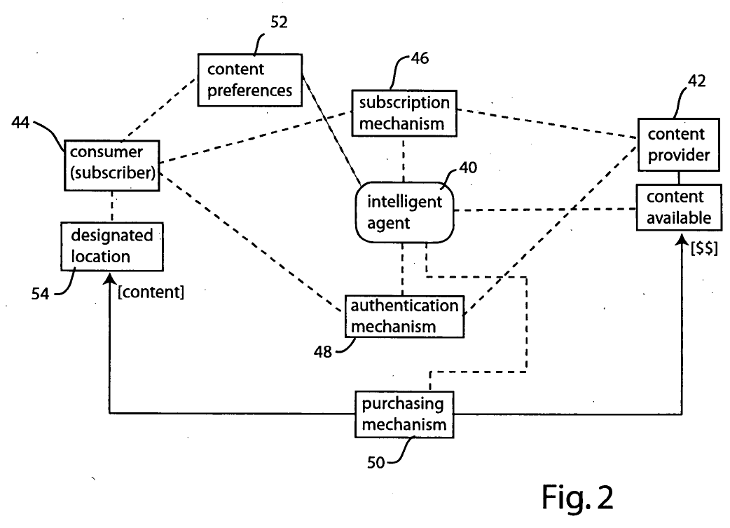

Referring to FIG. 2, the infrastructure employed in a presently preferred embodiment of the media management system is illustrated. At the heart of the system is an intelligent agent entity 40. The intelligent agent can be deployed on a single platform or it may be distributed across multiple platforms and may be hosted by a single CPU or processor, or by multiple CPUs or processors coupled to one another over a network.

The intelligent agent communicates with content providers, illustrated generally at 42 and with content consumers or subscribers illustrated at 44. The intelligent agent entity preferably includes a subscription mechanism 46 that the consumer or subscriber interacts with to let the intelligent agent know what content the consumer may be interested in downloading. The intelligent agent also includes an authentication mechanism 48 that serves to ascertain the identity of or to authenticate the identity of both the consumer (subscriber) 44 as well as the content provider 42. Finally, the intelligent agent 40 includes a purchasing mechanism 50 that is used to effect the commercial transaction between the consumer (subscriber) and the content provider. Because the architecture supports distributed embodiments, it bears noting that the intelligent agent 40 may employ embedded subscription mechanism 46 authentication mechanism 48 and purchasing mechanism 50, or any one or more of the three mechanisms can be deployed as separate entities, detached from the intelligent agent but accessible through communication with the intelligent agent.

The intelligent agent 40 is able to ascertain the content preferences of the consumer (subscriber). These content preferences are illustrated at 52. Content preferences 52 may be stored in a suitable data store either associated with the intelligent agent 40, with the consumer (subscriber) 44 or at a third location detached from both agent and consumer. In one embodiment, the consumer (subscriber) supplies information reflecting his or her content preferences and this information is then stored as content preferences 52. Alternatively, the media management system can discover or learn a consumer's content preferences by monitoring previous content purchases or downloads.

As was illustrated in FIG. 1, the content obtained from a given content provider can be delivered to a variety of different devices or locations, depending on the wishes of the consumer (subscriber). In FIG. 2, the box labeled “Designated location” 54 is intended to diagrammatically illustrate one or more such devices or locations (such as the ones illustrated in FIG. 1).

Before giving a detailed description of the intelligent agent and of the transactions effected by the media management system, a simple illustration of the system in operation will be provided in connection with FIG. 2. It should be kept in mind that this example is intended to illustrate one possible use of the system, but it is not exhaustive of all possibilities.

To begin, the consumer (subscriber) 44 engages the subscription mechanism 46 to, in effect, launch an intelligent agent 40 to act on the consumer's (subscriber's) behalf. Either at this time, or prior thereto, the consumer may provide his or her content preferences 52. The intelligent agent accesses these content preferences and then automatically begins seeking content available from various content providers that may meet the consumer's preferences. When the intelligent agent discovers content that would meet the consumer's content preferences, the intelligent agent locates a user device associated with that consumer and sends a communication to alert the consumer of the existence of possible content of interest. The manner in which the consumer is notified is automatically formatted to suit the user's current device. Thus a scrolling message or picture-in-picture message might be displayed on a user's TV, whereas a more simple message such as a special call or text message would be sent to a user's cell phone.

Then, depending on the election of the user (which may in some cases be established in advance) the intelligent agent uses its authentication mechanism to ensure the authenticity of both parties and then invokes the purchasing mechanism to effect a commercial transaction between consumer and content provider. At the consummation of the commercial transaction the content provider delivers the desired content to the designated location 54 established by the user.

Depending on the user's desires, the operation described above can take place with minimal or no user interaction. The degree of control afforded the user is ultimately the user's choice. In some cases a user will want to have the final say as to whether certain content will be delivered or not. In other cases the user will rely on the intelligent agent to handle the entire transaction without the user's active involvement.

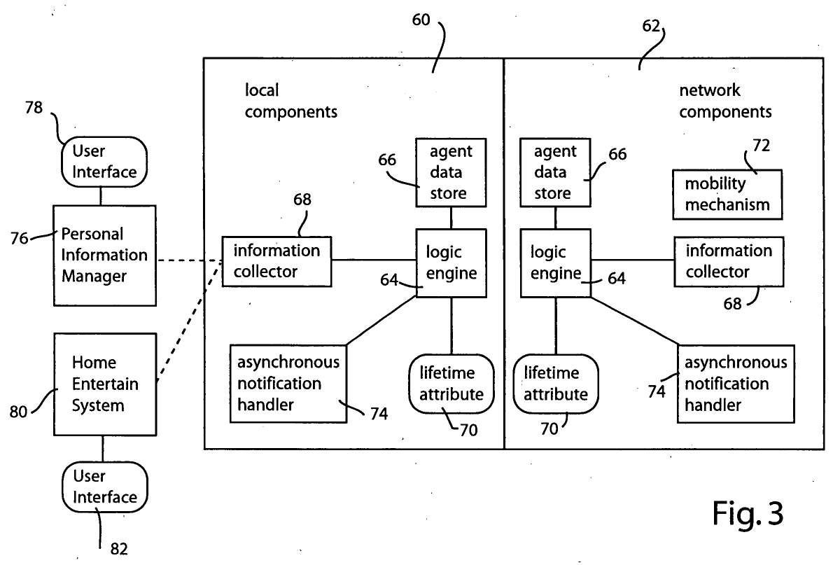

Referring now to FIG. 3, an intelligent agent 40 has been illustrated in greater detail. The intelligent agent comprises a local component 60 and a network component 62. Each of these components has a logic engine 64 and an associated agent data store 66. Both local and network components also employ an information collector 68 by which information is gathered, processed by the logic engine and stored in the agent data store.

By having both local and networked components, the intelligent agent can operate in a distributed fashion, as will be more fully described below. One of the properties of the intelligent agent is that it has a definite lifetime. That is, once instantiated or launched, the intelligent agent may be configured to terminate at a predetermined time or after a predetermined set of conditions are met, thereby freeing up the processor supporting the intelligent agent. Accordingly, the illustrated intelligent agent of FIG. 3 includes a lifetime attribute 70 that may be used to determine when the intelligent agent should terminate.

Another property of the intelligent agent is mobility. Thus the network component 62 has a mobility mechanism 72 by which the network component can move about from place to place within the network. In one embodiment, the mobility mechanism is effected by copying or replicating the network component into different memory spaces (across different devices on the network). In an alternate embodiment, mobility is effected by moving a pointer (e.g., URL) to access different memory spaces associated with different devices across a network such that the network component “visits” different locations within cyberspace. Thus, in one form, the agent gathers information as to where the needed information can be found, and then goes to those locations to obtain it. In another form, the agents are, in effect, distributed and communicate with each other—such that the individual agents harvest different portions of the information and report it back to the user.

Both the local and network components collect information (using the information collectors 68) and build intelligence which is then stored as data in the respective data stores 66. By virtue of the mobility mechanism, the intelligent agent is able to locate desired resources, based on the user's preferences, and the like. The agent then notifies the user by sending an appropriate message to one of the user's designated devices. In this regard, the intelligent agent employs an asynchronous notification handler 74 that takes control over the receipt and dispatching of asynchronous messages. The asynchronous notification handler is also used to handle asynchronous messages between the intelligent agent and other content provider resources on the network.

The intelligent agent architecture is configured so that the local component dispatches and then communicates with the network component. The local component has an interface to connect with user devices and resources to obtain information about the user's location, schedule, preferences and about all local devices and their capabilities. In FIG. 3, the information collector 68 of the local component is shown communicating with a user's personal information manager 76 to obtain this information from the user through a user interface 78 associated with the personal information manager. By way of further example, the information collector is also shown communicating with a home entertainment system 80 having a user interface 82 through which the user can provide information about the user's location, schedule, preferences and about local devices and their capabilities. In the presently preferred embodiment the intelligent agent exists in the user's virtual domain. In this regard, the user's virtual domain is very similar to a private virtual domain of a virtual private network (VPN). The user may have several networks (such as at different places the user frequents, e.g., residence, vacation home, office, etc.) interconnected together. All of these interconnected networks would define the user's virtual domain. The agent's logic engine is configured so that if the likelihood of a search being satisfied by a given item is greater than a predetermined threshold, the user will be notified.

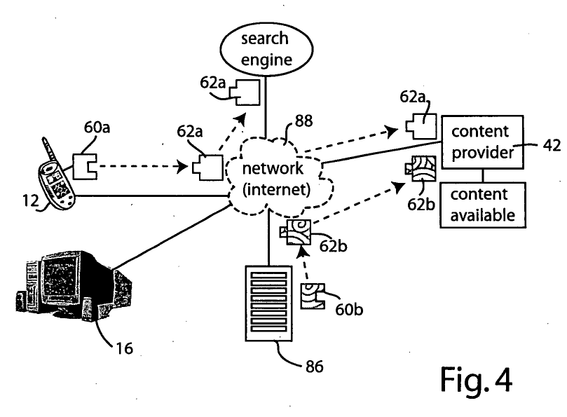

In the presently preferred embodiment the media management system employs two kinds of agents: agents that originate from a client device and agents that originate from a network server. Referring to FIG. 4, a client device such as cellular telephone 12 employs a client-side agent having a local component 60a and a network component 62a. Local component 60a sends out the network component 62a and the network component then uses its mobility mechanism (see FIG. 3) to visit or access different locations across the network 88. For example, the client-side agent may be sent out to get information from the network regarding promotions, pricing, content availability and the like. The client-side agent is also responsible for ascertaining local user information such as the user's viewing preferences and a list of available devices accessible to the user such as home devices. In FIG. 4 an exemplary home device, mainly a personal computer 16 has been illustrated.

The client-side agent may be downloaded using its mobility mechanism to a search engine 90 (e.g., Google) to look for something. When the search engine discovers it, the network component 62a of the client-side agent is made aware of the discovery and reports back to the user asynchronously using the asynchronous notification handler 74 (FIG. 3).

In a similar fashion, server-side agents are launched from and use their mobility properties to gather information. In FIG. 4, the local component 60b and the network component 62b of a server-side agent have been illustrated. The server-side agent (60b, 62b) originates from a server 86 that is coupled to the network 88. The server-side agent gathers information such as user viewing preferences that may be suitable to the needs of the server. For example, the server-agent may gather viewing preference information to assist in focusing an advertising campaign to the relevant market.

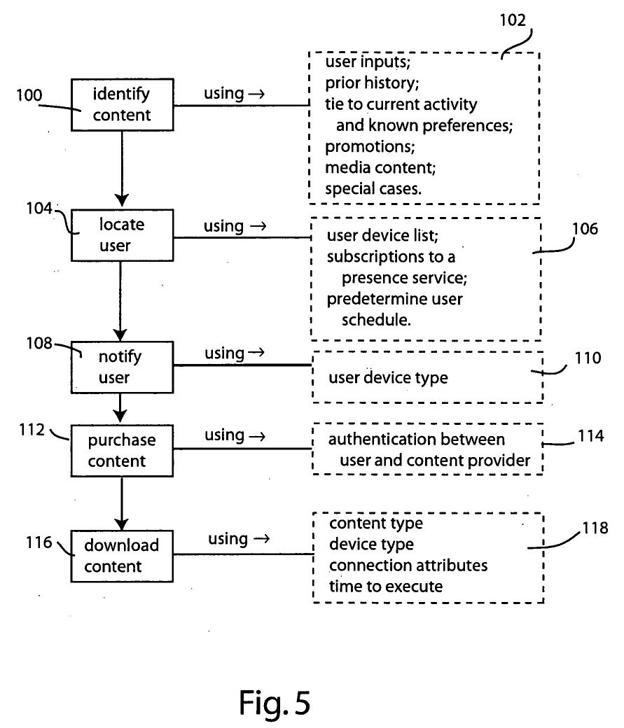

With the foregoing media management system and intelligent agent architecture in mind, refer now to FIG. 5 which presents a detailed description of an exemplary transaction using the media management system. The intelligent agent is involved in each of these steps: identify content 100, locate user 104, notify user 108, purchase content 112 and download content 116.

The identify content step 100 is performed automatically by the intelligent agent. The intelligent agent thus automatically recommends content for purchase, based on preferences established by the preference items identified in block 102. User inputs may be manually entered as preferences. The prior history of purchases may comprise an updated conglomerate of preferences previously established. The tie-in with current activity and known preferences uses knowledge of the user's current activity and known preferences to make suggestions of additional content the user may be interested in. For example, if the user is currently listening to or viewing information related to a particular song, the system can suggest other songs for download. Similarly, if the user is currently viewing a movie, the system can suggest songs, video games or the like that may be of interest to the user in the context of the movie being watched.

The identify content step 100 can be extended to support commercial activities such as product or service promotions. In this regard, a possibly interesting item of content that is now offered at a reduced price (or some other beneficial attribute) can be identified for suggestion to the user. The intelligent agent is aware of the media content. Thus it can actively engage the user in a dialogue using the asynchronous notification handler to ask if the user wants to download an item of content that there's a relation to the content the user is currently viewing. For example, while the user is watching a movie, the intelligent agent may ask the user if he or she wants to download a related game or a theme song for use as a ring tone in the user's cellular telephone.

The identify content step 100 is also capable of handling special cases. These include a case where a user communicated directly with the agent for the purchase of arbitrary content and the case where a user communicates directly with the agent for the purchase of content at some time in the future. In this latter case the user would register to buy a movie before it has been released for general purchase, for example.

The locate user step 104 uses the intelligent agent to locate the user using the attributes identified in block 106. In this regard, the user may have various communication devices (e.g., cell phone, integrated DTV, set-top box, personal computer, and the like) with subscriptions to a presence service. Presence services are often utilized in conjunction with instant messaging systems and serve as a network-based way of notifying third parties when the user is available for instant messaging. Some of these services also provide information about the user's geographic location and/or the capabilities of the user's communication device. There can be multiple devices subscribing to the same service and these may be arranged in some priority order. Thus if the primary device is not turned on, an alternate device can receive the instant message. The intelligent agent is capable of sending queries to the user's presence service to find an “address” and corresponding device for the user. As an alternative to employing a presence service, the user can also establish a predetermined user schedule and the intelligent agent will then consult that schedule to determine which user device should be used to send notifications.

The notify user step 108 involves the basic function of sending a notification to the user once content has been identified and the user has been located. In this step the intelligent agent automatically configures the notification message based on the user's current device. By way of example, if the user's current device is a television, the notification message might be scrolled as a message at the bottom of the screen or it might be included using a picture-in-picture capability of the television set. Similarly, if the user's device is a cellular telephone, the intelligent agent might configure the message as a special call placed to the cellular phone or as a text message sent to the cellular phone. If the user's current device is a game machine, the intelligent agent (based on the user's preferences) might cause the current game being played to pause if the newly discovered content has a high enough priority. Otherwise, the user would be notified during a suitable break during or after the game.

Thus it will be appreciated that the intelligent agent, using the local component, is able to ascertain status (e.g. from state information or other means) related to the user's device. In this case, the intelligent agent is able to access the status (e.g., through state information) indicating the state of play, thereby allowing the agent to send a message during a suitable break or after the game. The intelligent agent is also capable of interacting with the status (e.g., state information) of the device thereby allowing the intelligent agent to change the state information and thus cause the device to change its operation. This aspect might be used, for example, to cause a game machine to pause if new content of sufficiently high priority is discovered.

If the user device is a personal computer, the notification may be sent in the form of a pop up window, for example. If the user device is within a car, an auxiliary message may be sent to the vehicle such as using satellite radio, or interacting with the vehicle navigation system to provide a visual message.

Although different forms of notifications are possible, a presently preferred embodiment makes the purchase of content easy by giving the user a simple question for which a yes/no response is all that is required. All other details of the transaction may be predetermined (including the user's credit card account information and the identity of all parties involved and the content desired to be downloaded). The system can be further configured so that other responses may be used to override any defaults. These would include the time for download and the device on which to download.

The purchase content step 112 uses the authentication techniques between the user and the content provider. The intelligent agent is configured to support one or more of a variety of different authentication mechanisms, including public key encryption systems and the like. The intelligent agent is configured to make a secure connection using whatever network is available to perform the purchase transaction. Also, as previously noted, although many types of media are made available for purchase, the media management system of the invention is not restricted to purchase transactions involving an exchange of money. The system will also support free transactions. In this case, the purchase content step 112 may not necessarily require consideration in the form of money. Even with “free” content purchases, the authentication mechanisms may still be used, if desired, to ensure that computer viruses and other undesirable content is not spread.

The download content step 116 is mediated by the intelligent agent based on the user device identified to receive the download. The intelligent agent takes into account the attributes identified in block 118. Thus the intelligent agent takes into account the type of content, the desired physical device to receive the download, the type of connection the device has with the content provider, the time required to carry out the download as well as other aspects involved in the data transfer. The intelligent agent is aware of the content type and will thus not download content to a device for which that content is not appropriate. A processor-intensive game, for example, would be downloaded to a game machine but not to a cellular phone. The type of connection (e.g., cable TV network, direct Internet, Internet through gateway, Bluetooth and combinations of the above) will affect the time needed to carry out the download. In addition, the intelligent agent can make decisions about the download timing to take into account factors such as the cost to effect an immediate download, the cost to effect a download at a later time when the bandwidth cost is less expensive and a manual override of a preferred time to allow the user to take control.

The intelligent agent is preferably configured to include the basic capabilities needed to support the process steps identified in FIG. 5. Depending on a particular application program, the intelligent agent can be further configured to support additional features and requirements associated with particular devices. Some examples of these additional aspects will be next presented.

When the user device employs a Cable CARD, the intelligent agent will need to interact with the Cable CARD. The Cable CARD has information on it that gives the user authority to receive certain content. These are often provided in the form of a Smartcard that is plugged into a user's set-top box. Future generation Cable CARDs may be incorporated into the set-top box with authorization being dynamically downloaded to it to support multiple content providers. The intelligent agent is configured to access the information on the Cable CARD in order to mediate the content purchase and download steps. Where the device is a video recorder such as a PVR the intelligent agent is configured to tap into the PVR data store. Current PVR systems store information locally. In the future, information may be stored on a network-based PVR accessible from the user's system but not stored locally. In this case the intelligent agent would tap into the network PVR. One important advantage provided by the intelligent agent system is that if the user forgets to save some content, the agent can still search for it in the network PVR and then download it.

The intelligent agent can perform automated backups of content on the PVR. The agent has knowledge of what is important and what needs to be available, based on the user's preferences. Similarly, the intelligent agent knows what is less important and thus can be pushed to secondary storage. The intelligent agent can download content to a device such as a PVR even if no one is home to request it. The agent can determine the importance of the content and make a provisional purchase. If the user determines that the content is worthy, the purchase can be finalized. The advantage of the provisional purchase is that the user does not have to undergo a lengthy wait for the download process to occur, as it has already transpired. With the provisional purchase the user simply needs to consummate the purchased transaction and a key or authentication code is then delivered to allow the user to enjoy the downloaded content.

If the device is a cellular phone, the intelligent agent may be configured to supply ring tones to the phone. Ring tones are downloadable data files. The intelligent agent can mediate the downloading of the ring tone files. The intelligent agent can do more, however, the intelligent agent may be configured to transcode music from content being viewed or listened to or convert that music into a ring tone.

At the end of a movie, the intelligent agent may ask questions about what the user liked and did not like, in order to build up its preference knowledge data store. Thus the intelligent agent can also be used to implement parental control. The intelligent agent can override the conditional access using the agent's parental control preferences. Criteria for downloads can be based on the agent's parental control abilities. Finally, the agent can notify a parent and request permission from that parent for “questionable” downloads. As movie content moves more to a view-on-demand model, control over download decisions becomes more important, particularly where parental control is desired. The intelligent agent can take into account not only parental control preferences but also movie ratings supplied from the service providers in determining whether a particular content will be downloaded.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A media management system for interacting with at least one user device for the discovery, acquisition and delivery of media content over a network, comprising:
an intelligent agent having a local component associated with a user device;
said intelligent agent having a network component that communicates with said local component and that has a mobility mechanism allowing said network component to visit different locations across said network to seek out media content;
said intelligent agent having a data store in which user preferences are stored
said intelligent agent being adapted to mediate the automatic acquisition and delivery of media content from a content provider to a user device based on said user preferences.

2. The media management system of claim 1 wherein said intelligent agent is adapted to communicate with a purchasing mechanism to initiate a commercial transaction associated with said acquisition and delivery of media content.

3. The media management system of claim 1 wherein said intelligent agent has an asynchronous notification handler adapted to provide a notification message to a user device when said network component discovers media content that meets the user's preferences.

4. The media management system of claim 1 wherein said intelligent agent has an information collector adapted to locate the user in order to deliver a notification related to media content.

5. The media management system of claim 4 wherein said information collector is adapted to access a presence service to locate the user.

6. The media management system of claim 4 wherein said information collector is adapted to access a stored user schedule to locate the user.

7. The media management system of claim 1 wherein said intelligent agent has a notification system configured to automatically compose and format notification messages configured to match the user device capabilities.

8. The media management system of claim 1 wherein said intelligent agent is adapted to access an authentication mechanism that authenticates the user.

9. The media management system of claim 1 wherein said intelligent agent is adapted to access an authentication mechanism that authenticates a provider of media content.

10. The media management system of claim 1 wherein said intelligent agent interacts with a subscription mechanism to mediate a media content subscription between the user and a provider of media content.

11. The media management system of claim 1 wherein said intelligent agent includes a notification system configured to supply notification messages to the user via a user device and wherein said intelligent agent is adapted to selectively cause said delivery of media content to be routed to a user device other than the user device employed in providing the notification message.

12. The media management system of claim 1 wherein said intelligent agent uses said mobility mechanism to pre-fetch data from other components in the network for storage until later use.

13. The media management system of claim 1 wherein said intelligent agent uses said mobility mechanism to fetch information in real time.

14. A method of managing the discovery, acquisition and delivery of media content over a network, comprising the steps of:
associating an intelligent agent with a user device;
employing a mobility mechanism associated with said intelligent agent to identify content in accordance with user preferences;
using said intelligent agent to mediate the automatic acquisition and delivery of media content from a content provider to a user device based on said user preferences.

15. The method of claim 14 further comprising using said intelligent agent to locate the user and provide notification message to the user regarding said identified content.

16. The method of claim 14 further comprising using said intelligent agent to initiate a commercial transaction associated with said acquisition and delivery of media content.

17. The method of claim 14 further comprising using said intelligent agent to interact with an authentication mechanism to authenticate at least one of said user and a provider of media content.

18. The method of claim 14 further comprising using said intelligent agent to mediate the downloading of media content to a user device.

19. The method of claim 18 wherein said intelligent agent causes the downloading to conform to the physical requirements of the user device and the communication channel over which the media content is downloaded.

20. The method of claim 14 wherein said intelligent agent mediates when the delivery of media content takes place based on predefined preferences.

21. The method of claim 14 wherein said intelligent agent effects a change in media content format so that the media content delivered to a user device is appropriate to the physical capabilities of that device.

22. The method of claim 14 wherein said intelligent agent discovers user preferences by monitoring user behavior through use of said user device.

23. The method of claim 14 wherein said intelligent agent supports acquisition of a first media content while the user is enjoying a second media content.

24. The method of claim 14 wherein said intelligent agent initiates a provisional purchase transaction whereby media content is provisionally purchased prior to user interaction and then subsequently made available to the user for immediate enjoyment upon receipt of user confirmation.
